(19) United States
(12) Patent Application Publication
(10) Pub. No.: US 2009/0187390 A1
(43) Pub. Date: Jul. 23, 2009

(54) Engine Transition Test Instrument and Method

(75) Inventor: Yasunori Urano, Tokyo (JP)

Correspondence Address: SMITH, GAMBRELL & RUSSELL, 1130 CONNECTICUT AVENUE, N.W., SUITE 1130, WASHINGTON, DC, 20036, US

(73) Assignee: HINO MOTORS, LTD., Tokyo (JP)

(21) Appl. No.: 10/585,406

(22) PCT Filed: Jan. 7, 2005
(86) PCT No.: PCT/JP2005/000131

§ 371 Date: Jul. 7, 2006

(30) Foreign Application Priority Data
Jan. 9, 2004 (JP) 2004-004323
Jan. 9, 2004 (JP) 2004-004342

(51) Int. Cl. G06G 7/48; G01M 15/00

(52) U.S. Cl. 703/7

(57) ABSTRACT

A transition test on an engine is conducted by simulation using a simulation model of the engine. In the test, the operator can visually grasp the setting state of a control value of the engine when setting the control value. The simulation results and the control value used for the simulation are displayed in time series with graphs. The graph of the control value displayed in time series is drag-operated in the display screen to manually alter the control value.

### TECHNICAL FIELD

The present invention is used for a transition test of engines (internal combustion engines). In particular, the present invention relates to a transition test method used for adapting the transition characteristics and performance of diesel engines to the required performance objectives and a system for the same. The present invention is designed to quickly build an engine control system satisfying the transition performance objectives of an engine.

### BACKGROUND ART

The term “transition characteristics of an engine” refers not to characteristics obtained in the steady state, in which the rotational speed and torque remain constant, but to characteristics obtained in cases, in which they change with time. For instance, it refers to engine characteristics in states, in which the speed etc. changes, such as during acceleration or during deceleration.

The measurement of output characteristics of a conventional engine, such as the torque output, exhaust-gas, etc., in the transition states of the engine has been conducted using a technique, in which an actual engine is brought into the steady state, the output state of the engine is subjected to measurement, and the output of the engine is then estimated by substitution with transition state characteristics obtained by weighting the steady-state output data.

However, the measurement of steady-state engine characteristics has been a time consuming procedure in which after altering the control value of a controlled factor (e.g. the quantity of injected fuel, fuel injection timing, etc.) of an engine, one would wait until a predetermined time (e.g. 3 minutes) passes before the steady state is reached and then measure the output in this state, where one would alter the control value of one controlled factor, conduct measurements upon lapse of a predetermined time after reaching the steady state, and then again alter the control value of a controlled factor and conduct measurements, etc.

In an actual vehicle, during travel, the engine spends more time in a state of acceleration or deceleration and less time in a state permitting travel at a constant speed. For this reason, it is important to measure engine characteristics in transition states. In addition, in recent years, exhaust emissions regulations have been directed not at regulation based on the steady-state exhaust values of an engine, as was done before, but at regulation based on regulatory values related to the transition-state exhaust of an engine. Consequently, it has become important to measure transition characteristics that define what kind of transition state exhaust is obtained when certain alterations are made to certain controlled factors.

Even during steady-state characteristic measurement, which was conducted, as described above, in order to determine what kind of output would be obtained if alterations were made to the controlled factors of an engine in the steady-state, there were numerous controlled factors, with a particularly large number of controlled factors appearing when engine control was carried out by means of ECU-based electronic control, as a result of which the length of the test increased. For instance, parameters were added for various types of electronic control involved in engine control, such as EGR (Exhaust Gas Recirculation) valve control or VGT (Variable Geometry Turbo) control. During transition characteristic measurement, in a state in which the rotational speed and torque of the engine vary in the form of a time series, it is natural that the output data, likewise of the engine appear as data varying in the form of a time series, as a result of which the number of controlled factors increases and the length of the test grows exponentially if measurements are attempted in the steady state by altering the control values of every single controlled factor.

For this reason, technology has been proposed, in which engine control etc. is evaluated using simulation virtually reproducing the characteristics of the engine and the vehicle (see Patent Document 1).

In this technology a virtual vehicle model, complete with an engine, is created for each vehicle type in a simulator in advance, whereupon various control inputs, for instance, control values for the slit aperture, crank angle, and other controlled factors, are inputted into the vehicle model, and an attempt is made to estimate engine rotational speed, vehicle speed, and exhaust temperature sensor values as outputs of the virtual vehicle model based on the inputted control values.

Patent Document 1: JP H7-221763A

### DISCLOSURE OF INVENTION

### Problem to be Solved by the Invention

Because the number of controlled factors used in an engine has increased in recent years, when measurement of steady state and transition state characteristics is attempted in an actual engine, as described above, it takes a long time to obtain test data, which has become a bottleneck in engine development.

In addition, the technique consisting in deploying a vehicle model, including a virtual engine model, in a simulator and using it to observe the behavior of the engine is useful in terms of allowing for reductions in the length of engine development. However, in the above-described publicly known documents, the purpose is to build a simulation of a vehicle model and not to create a simulation of transition state phenomena in an engine and use it to evaluate required performance in the transition states of the engine. In addition, poor operability has been a problem in case of altering the control values of the respective controlled factors of an engine according to the transition state and estimating their results.

The present invention has been devised in consideration of these issues, and the objective thereof is to provide an engine transition test instrument and method that allow reduction of time required for the engine transition test. In addition, another objective of the present invention is provide an engine transition test instrument and method that enable an operator to visually perceive the setting conditions of control values when setting engine control values that satisfy the performance objectives required for an engine in the transition states. Accordingly, yet another objective of the present invention is to provide an engine transition test instrument and method that allow for reductions in the length of engine development.

### Means for Solving Problem

In general, when conducting an engine transition test, initially a simulation is performed using a simulated engine model. Specifically, control values are set to a virtual ECU (Electronic Control Unit or Engine Control Unit) that emulates an ECU that controls the engine, and control signals are supplied to the simulated model based on the control values. When control values with which the simulated model satisfies the objective performance are obtained, the control values are set to an actual ECU to conduct the transition test on an actual engine.

Although the best mode of the control values is examined in such a simulation, an operator is required to alter the control values manually. The present invention assists the operation (tuning) by the operator.

Specifically, according to the first aspect of the present invention, an engine transition test instrument is provided that includes virtual engine test means for simulating a transition state in which an engine rotational speed or torque changes with time, wherein the virtual engine test means includes simulation means for simulating behavior of an engine by a transition engine model created based on data obtained by driving an actual engine while changing a value of at least one controlled factor, virtual control means that emulates actual control means that controls an actual engine, and supplies an engine control signal to the simulation means, and control value operation means that supplies a control value for the controlled factor to the virtual control means, causes simulation results by the simulation means to be displayed on display means of an operator, and corrects the control value according to an operation by the operator, wherein the control value operation means includes means for causing a control value used for the simulation to be displayed in a time-series graph on the display means along with the simulation results.

It is possible to further include means for conducting a transition test on an actual engine using a control value corrected by the control value operation means, and means for updating a transition engine model in the simulation means based on test results by the means for conducting the transition test.

With the engine transition test instrument of the present invention, by displaying in a time-series graph the control values used when performing the simulation along with the simulation execution results, it becomes easy for the operator to visually perceive the corresponding relation between the simulation execution results and the control values.

It is preferable that the control value operation means updates a control value according to a drag operation by an operator with respect to the control value displayed as a graph on the displaying means. As a result, it becomes possible for the operator to perform correct operations of the control values while visually perceiving the corresponding relation between the simulation execution results and the control values. Accordingly, the corresponding relation, that is, what kind of change in the simulation execution results is obtained when certain alterations are made to certain control values, can be recognized on an experimental basis, and therefore it becomes easy to quickly obtain the results satisfying performance objectives required of the engine in a transition state.

It is preferable that the control value operation means causes a target value for a simulation by the simulation means to be displayed on the display means in parallel with simulation results.

It is preferable that with respect to a portion in which the difference between simulation results and a target value exceeds a permissible limit, the control value operation means causes the simulation results to be displayed in a display pattern different from that for the other portions. In addition, it is preferable that with respect to a control value that corresponds to a portion in which the difference between simulation results and a target value exceeds a permissible limit, the control value is caused to be displayed in a display pattern different from that for the other portions. As a result, the operator can promptly perceive the portion to be reexamined in the simulation results, thereby increasing the operation efficiency of the operator.

It is possible to divide the simulation time into time slits of a unit period of time, and cause a time slit in which an integrated value of the difference between simulation results and a target value exceeds a threshold value to be displayed in a display pattern different from that for the other time slits. In this way, it is possible to remove values of the simulation results that have a peak like a short pulse, and detect a portion that exceeds the permissible limit. Therefore, detection with good precision is possible.

According to the second aspect of the present invention, an engine transition test method is provided that includes a first step of creating a transition engine model created based on data obtained by driving an actual engine while changing a value of at least one controlled factor in a transition state in which an engine rotational speed or torque changes with time, a second step of assuming the transition engine model as a virtual engine, and displaying a control value for the controlled factor for operating the virtual engine, a third step of emulating actual control means that controls an actual engine and supplying an engine control signal to the virtual engine based on the control value, a fourth step of displaying simulation results of operating the virtual engine according to the engine control signal, and a fifth step of correcting the control value according to the displayed simulation results, wherein the second through the fifth steps are repeated until the simulation results satisfy a performance objective, in the second step, the control value is displayed in a time-series graph, and in the fourth step, the simulation results are displayed in parallel with the graph display of the control value.

It is possible to further include a sixth step of providing a control value with which a performance objective has been satisfied by repeating the second through the fifth steps to control means of an actual engine, and conducting an actual transition test with the actual engine, and a seventh step of updating the transition engine model based on results of the transition test, wherein the second through the fifth steps are repeated with the updated transition engine model.

It is preferable that in the fifth step, with respect to the control value displayed in a graph in the second step, the control value is updated by an operator performing a dragging operation.

It is possible that in the second step or the fourth step, a target value for a simulation is displayed in parallel with simulation results in the fourth step.

It is preferable that in the fourth step, with respect to a portion in which the difference between simulation results and a target value exceeds a permissible limit, the simulation results of that portion are displayed in a display pattern different from that for the other portions. It is preferable that in the fourth step, a control value corresponding to a portion in which the difference between simulation results and a target value exceeds a permissible limit is displayed in a display pattern different from that for the other portions.

It is possible that in the fourth step, the simulation time is divided into time slits of a unit period of time, and a time slit in which an integrated value of the difference between simulation results and a target value exceeds a threshold value is displayed in a display pattern different from that for the other time slits.

According to the third aspect of the present invention, a computer program is provided that realizes, by being installed on an information processing system, simulation means for simulating behavior of an engine by a transition engine model created based on data obtained by driving an actual engine while changing a value of at least one controlled factor, virtual control means that emulates actual control means that controls an actual engine, and supplies an engine control signal to the simulation means, control value operation means that supplies a control value for the controlled factor to the virtual control means, causes simulation results by the simulation means to be displayed on a display screen of an operator, and corrects the control value according to an operation by the operator, and means for causing a control value used for the simulation to be displayed in a time-series graph on the display means along with the simulation results.

The computer program can be distributed as a storage medium that is readable by information processing systems, and also can be installed directly on the information processing systems via network. The present invention can be implemented using general information processing systems.

### Effects of the Invention

In the present invention, in setting engine control values that satisfy performance objectives, an operator can visually perceive the setting conditions of the control values. The present invention can reduce the time needed for engine development and can reduce the duration of product development.

### BRIEF DESCRIPTION OF DRAWINGS

FIG. 1 is a block diagram of an engine transition test instrument of the present invention;

FIG. 2 is a flowchart illustrating the overall flow of an engine transition test including a test on an actual engine;

FIG. 3 is a flowchart illustrating the flow of processes by a virtual engine test instrument;

FIG. 4 is a diagram for describing an example of data obtained in a transition state;

FIG. 5 is a diagram illustrating an example of display on the operator terminal by a control value operating unit;

FIG. 6 is a diagram illustrating an example of an operation for correcting a control value;

FIG. 7 is a diagram illustrating display examples of simulation results and target values;

FIG. 8 is a diagram illustrating display examples of current control values and target control values;

FIG. 9 is a diagram illustrating an example of compensation of delay between simulation results and a control value;

FIG. 10 is a flowchart illustrating another example of processes by the virtual engine test instrument;

FIG. 11 is a diagram illustrating a display example divided into time slits;

FIG. 12 is a diagram illustrating a display example in which time slits in which the permissible limits are exceeded are displayed in a different manner; and

FIG. 13 is a diagram illustrating a display example of a fuel injection quantity control value that can be used as a controlled factor;

### DESCRIPTION OF REFERENCE NUMERALS

1 Virtual Engine Test Instrument;

2 Model Creating Unit;

3 Virtual ECU;

4 Control Value Operating Unit;

5 Engine Simulating Unit;

6 Operator Terminal;

10 Actual Engine Transition Test Instrument;

11 ECU;

12 Engine;

13 Rotation Detector; and

14 Measurement Unit.

### BEST MODE FOR CARRYING OUT THE INVENTION

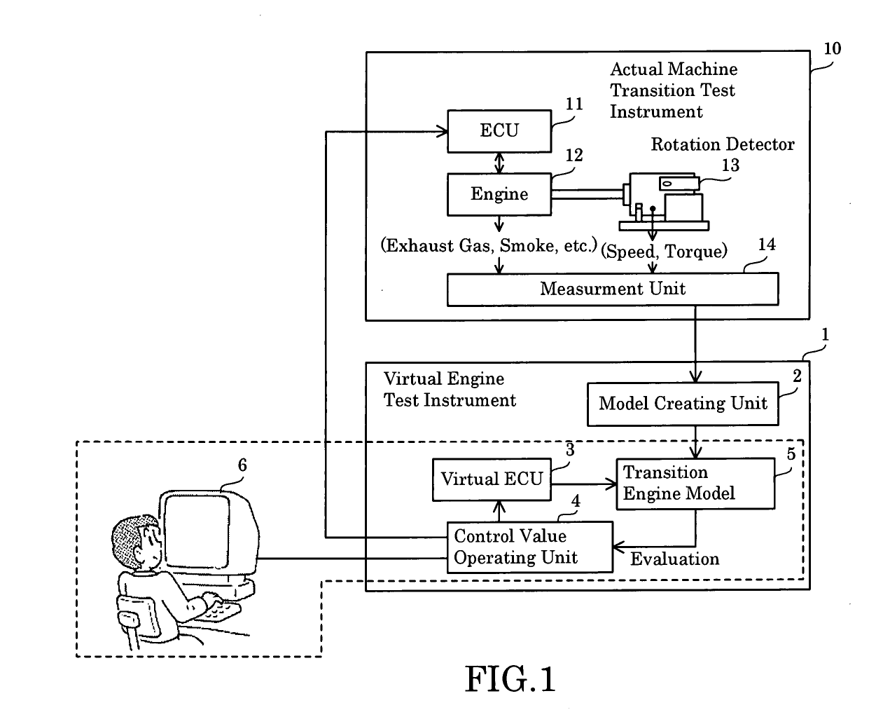

FIG. 1 is a block diagram of an engine transition test instrument of the present invention. The an engine transition test instrument is provided with a virtual engine test instrument 1 that simulates transition states in which the engine rotational speed or torque changes with time, and an actual engine transition test instrument 10 that conducts the transition test on an actual engine. The actual engine transition test instrument 10 is provided with an ECU 11 that controls an engine, an engine 12 controlled by the ECU 11, a rotation detector 13 used for detecting the rotational speed and torque of the crankshaft of the engine 12, and a measurement unit 14 used for exhaust gas, smoke, and other parameters (fuel consumption, etc.) of the engine 12 as well as the rotational speed output from the rotation detector 13.

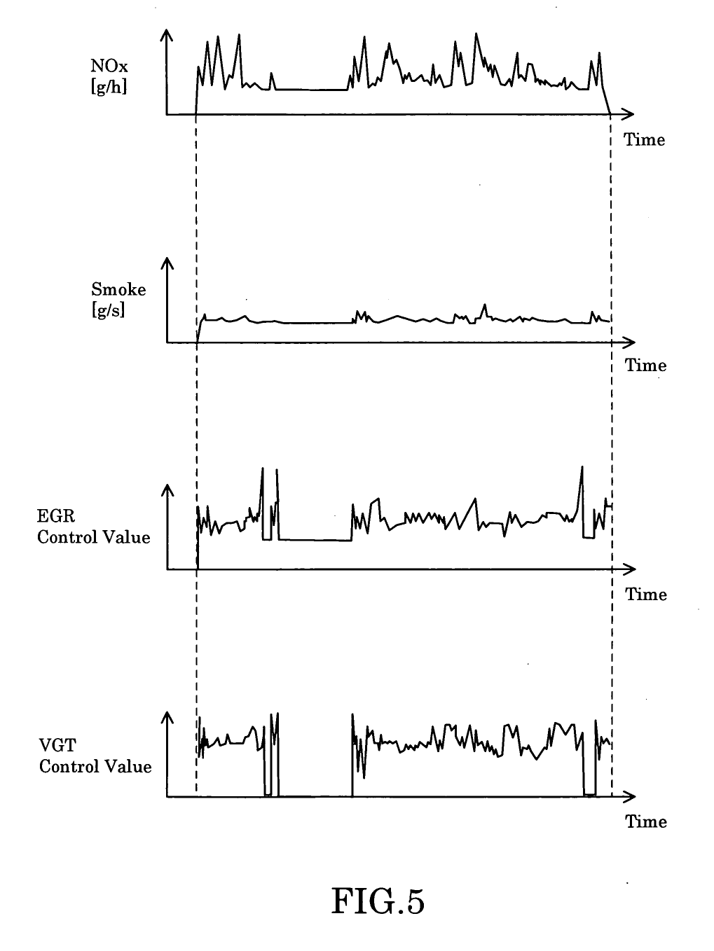

The virtual engine test instrument 1 is provided with an engine simulating unit 5 that simulates the behavior of the engine 12 by a transition engine model created based on data obtained by driving the engine 12 while changing a value of at least one controlled factor, a virtual ECU 3 that emulates the ECU11 and supplies engine control signals to the engine simulating unit 5, and a control value operating unit 4 that supplies control values for controlled factors to the virtual ECU 3, display the simulation results by the engine simulating unit 5 on the display screen of an operator terminal 6, and corrects the control values according to the operation by an operator. The control value operating unit 4 can display in a time-series graph the simulation results along with the control values used for such simulation on the display screen of the operator terminal 6 (see FIG. 5).

The virtual engine test instrument 1 also includes a model creating unit 2 that updates the transition engine model in the engine simulating unit 5 based on the test results obtained through the transition test on the engine 12 by providing the control values corrected by the control value operating unit 4 to the ECU11 of the actual engine transition test instrument 10, that is, the output from the measurement unit 14.

The actual engine transition test instrument 10 and the virtual engine test instrument 1 may not be arranged adjacent to each other. For example, the actual engine transition test instrument 10 and the virtual engine test instrument 1 may be connected to each other using LAN. Further, the virtual engine test instrument 1 and the operator terminal 6 may not be arranged adjacent to each other, and they may be also connected to each other using LAN.

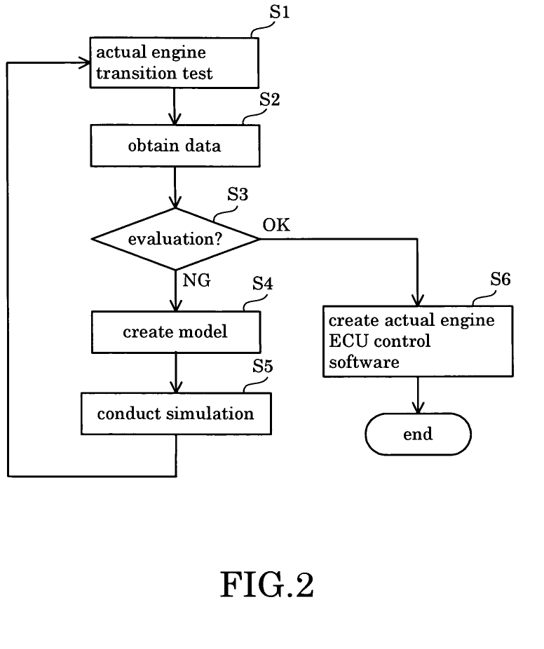

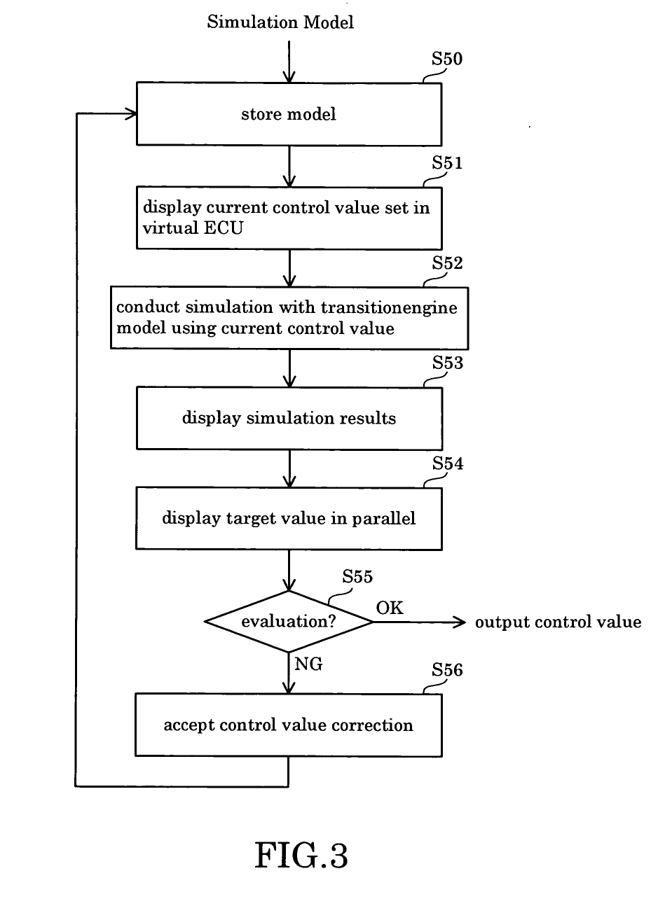

FIG. 2 is a flowchart illustrating the overall flow of the engine transition test including a test on an actual engine. FIG. 3 is a flowchart illustrating the flow of the processes by the virtual engine test instrument.

In order to conduct the engine transition test, the actual engine 12 is first driven while changing the value of at least one controlled factor in the transition state in which the engine rotational speed or torque changes with time (S1), and the measurement unit 14 obtains the resultant data (S2). A transition engine model is created in the model creating unit 2 using this data (S4), and a simulation is performed regarding the transition engine model as the virtual engine (S5).

In this simulation, the transition engine model created in the model creating unit 2 is stored in the engine simulating unit 5 (S50), and the control value operating unit 4 sets to the virtual ECU 3 the control values for the controlled factors for operating the virtual engine constituted by the transition engine model, and displays those control values on the operator terminal 6 (S51). The virtual ECU 3 emulates the ECU 11 that controls the engine 12, supplies engine control signals to the virtual engine in the engine simulating unit 5 based on the control values set by the control value operating unit 4, and performs the simulation (S52). The control value operating unit 4 displays the simulation results on the operator terminal 6 (S53), and at the same time displays the target values in parallel (S54). The operator sees the display to determine whether or not the performance objectives are satisfied (S55). If the performance objectives are not satisfied, the control value operating unit 4 accepts correction of the control values according to the simulation results displayed (S56). The above processes are repeated until the simulation results satisfy the performance objectives.

When the performance objectives have been satisfied by repeating the above processes, the relevant control values are supplied to the ECU 11, and the transition test is actually conducted in the engine 12 (S1). The measurement unit 14 obtains the resultant data (S2), and confirms the required transition performance objectives are actually satisfied (S3). If satisfied, those control values are used to create a control software for the ECU 11 (S6). If not satisfied, the transition engine model is updated in the model creating unit 2 (S4), and the simulation is performed (S5).

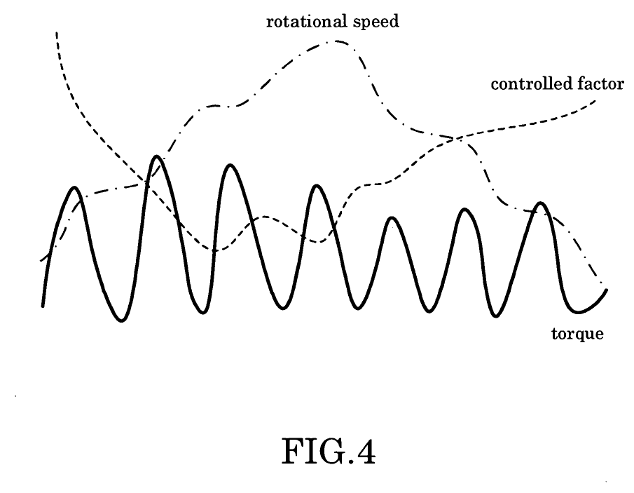

An example of data obtained from an actual engine in the transition state is described with reference to FIG. 4. As shown in FIG. 4, transition driving in which the rotational speed (alternate long and short dash line) and torque (solid line) change every second. At this time, the controlled factor of the ECU 11 is supplied to the engine 12 as shown by the dashed line. These rotational speed, torque and controlled factor are respectively recorded and displayed in the graph shown in FIG. 4. If delay is present between the change in the controlled factor and the change in the rotational speed and torque, they can be recorded and displayed after compensating such delay. As a result, the change in the rotational speed and torque corresponding to the change in the controlled factor can be expressly shown.

As a specific example, EGR and VGT are assumed as the controlled factors, the number of gram per hour (g/h) of NOx and the number of gram per second (g/s) of smoke are assumed as the index for the performance objectives. The EGR control value and the VGT control value are set to the ECU 11, based on which the engine 12 is controlled (S1 in FIG. 2). While the rotation detector 13 measures the rotational speed and torque and the measurement unit 14 takes in the resultant data, the measurement unit 14 measures the amount of NOx and smoke emitted by the engine 12 (S2). The model creating unit 2 creates a model based on the measurement results (S4), and stores the model in the engine simulating unit 5 (S50 in FIG. 3). Then, the simulation according to the above-described processes is started.

An example of display by the control value operating unit 4 on the operator terminal 6 is illustrated in FIG. 5. The control value operating unit 4 causes the emission amounts of NOx and smoke resulted from a simulation to be displayed on the operator terminal 6 in a time-series graph along with the EGR control value and the VGT control value used for that simulation. It is also possible to display the control value that was set to the ECU 11 at the first actual engine test and the resultant data measured by the measurement unit 14 as the initial value before performing the simulation.

In order to correct the control values set to the virtual ECU 3, the operator operates the control values displayed in a graph on the operator terminal 6 with mouse dragging. The control value operating unit 4 is notified of the operation condition at this time from the operator terminal 6, and the control value operating unit 4 then obtains a new control value and displays the same on the operator terminal 6. Accordingly, the control values can be altered while visually confirming the change of the graph shape.

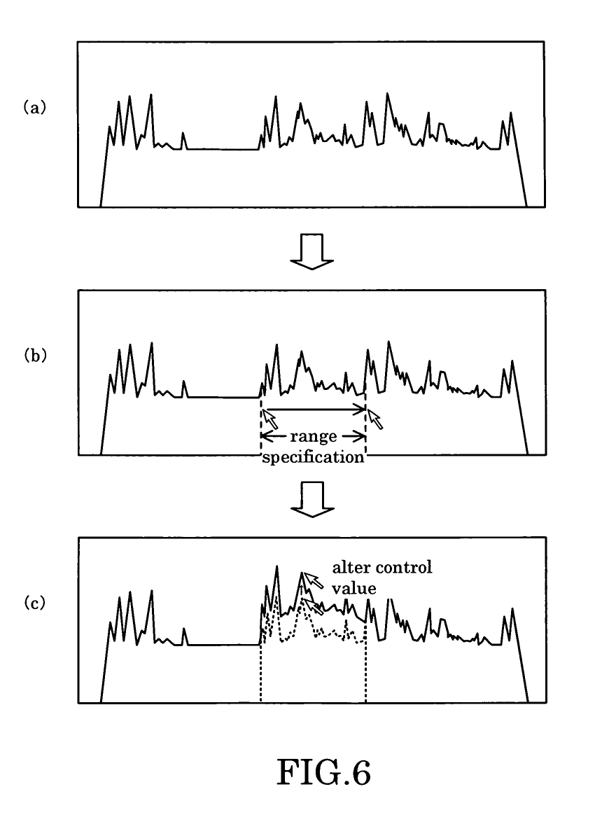

FIG. 6 illustrates an example of the operation for correcting the control values. First, with respect to the graph showing the current control values shown in FIG. 6(a), the range subject to alteration is specified in the lateral direction of the screen. This range is specified by dragging the pointer on the screen in the lateral direction by operating the mouse, as shown in FIG. 6(b). Subsequently, an increase/decrease extent of the alteration is specified in the vertical direction of the screen. This increase/decrease extent is specified by dragging the pointer on the screen in the vertical direction by operating the mouse, as shown in FIG. 6(c).

In addition to the correction of the control values by changing the graph shape, correction can be made also by inputting the control values directly from the operator terminal 6.

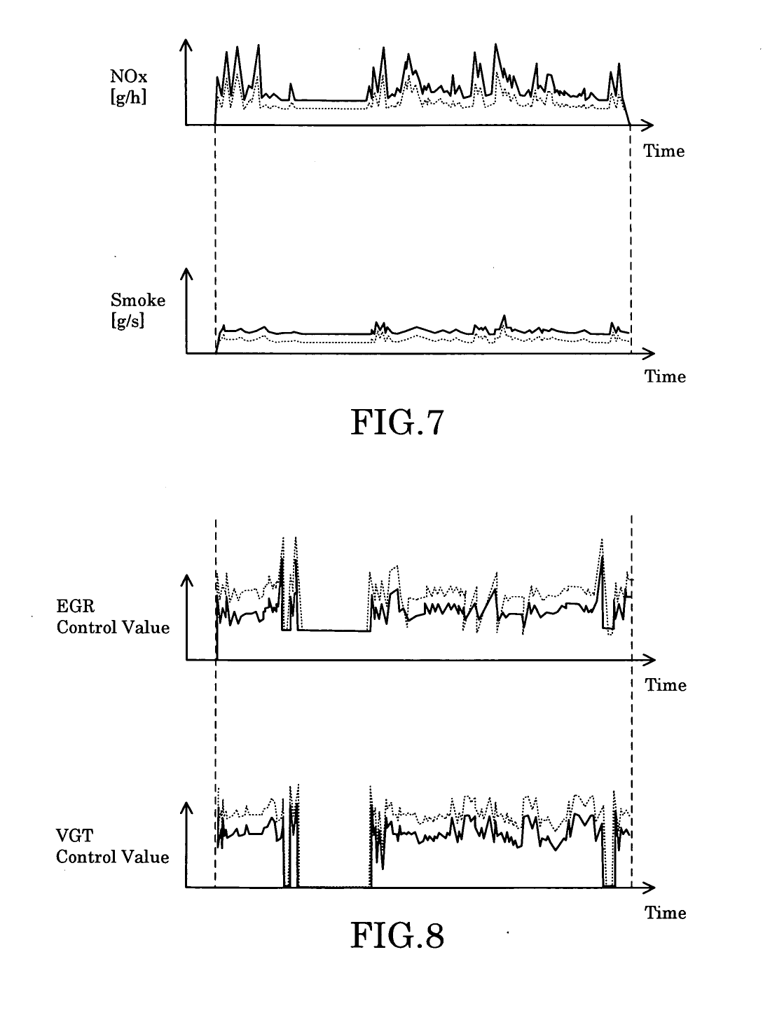

The target value for the simulation can be displayed in parallel with the simulation results. FIG. 7 shows an example of such a display. In this example, the simulation results (virtual measured value) of NOx and smoke are indicated by the solid line, and their target values are indicated by the dotted line. The operator determines if the difference between the virtual measured value and the target value is within the permissible limits. When the difference exceeds the limits, the operator corrects the control value so as to approximate the virtual measured value to the target value.

With respect to correction of the control values as well, it is preferable that the control value before and after correction are displayed in parallel. FIG. 8 shows an example of such a display in which the control value before correction is indicated by the solid line, and the control value after correction is indicated by the dotted line.

Control values corrected as described above are supplied to the virtual ECU 3 again, and the simulation is performed by the engine simulating unit 5.

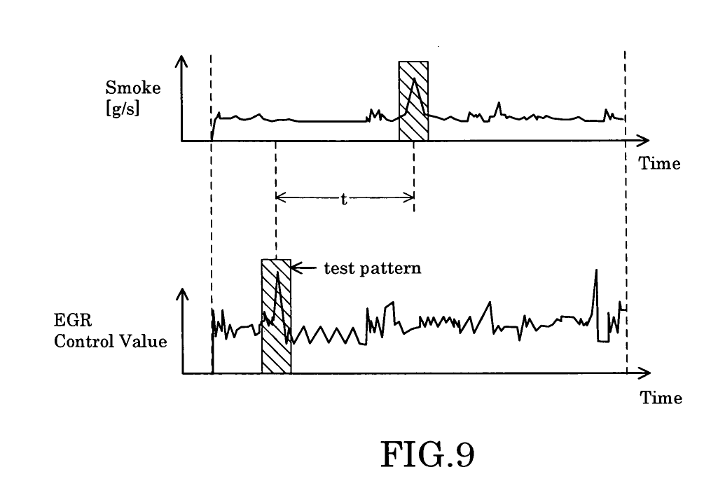

If any delay is present between the alteration of the control value and the simulation execution results, such delay can be compensated. FIG. 9 shows an example of compensation of such delay. A test pattern is inserted in order to intentionally cause a disturbance to the EGR control value. The effect of this disturbance appears in a time “t” later as a significant change in the amount of smoke. Based on that, it is found that there is a delay of a time “t” between the EGR control value and the amount of smoke. Therefore, it is possible to display the simulation execution results and the control value corresponding to each other in the form of a time series, by displaying them after compensating such delay. Delay present between other simulation execution results and control values can be also compensated in a similar manner.

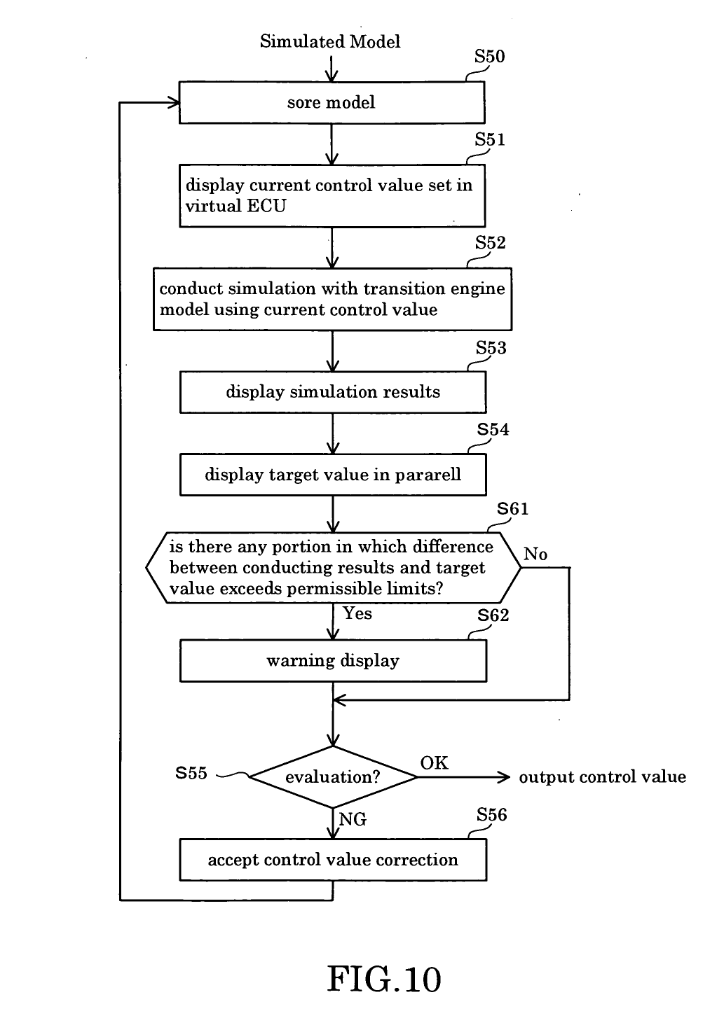

When the difference between the simulation results and the target value exceeds the permissible limits, the simulation results of a portion exceeding the permissible limits can be displayed in a display pattern different from that for the other portions. The flow of this process is illustrated in FIG. 10. This process describes a process involving the target value parallel display (S54) by the virtual engine test instrument. This process flow is different from the process flow illustrated in FIG. 3 in that after the control value operating unit 4 displays the simulation results and the target value on the operator terminal 6 (S53 and S54), it determines whether or not there is any portion in which the difference between the simulation execution results and the target value exceeds the permissible limits (S61), and if there is such a portion, performs warning display using a display pattern different from that for the other portions so that the operator can promptly notice the portion (S62).

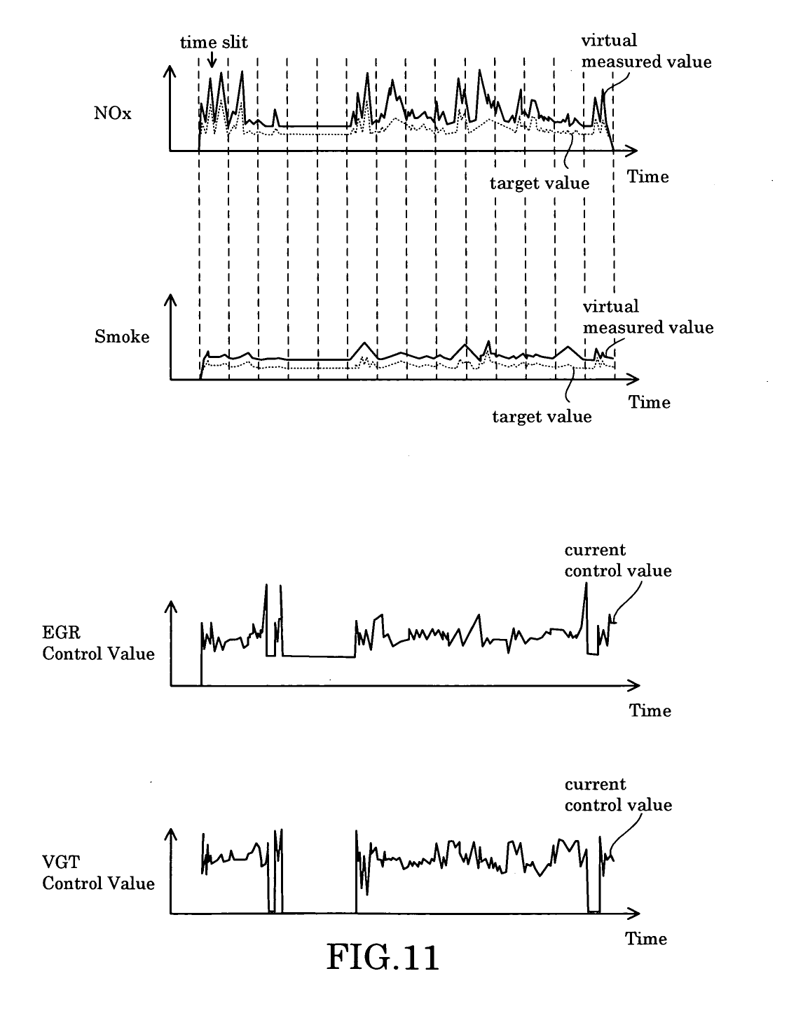

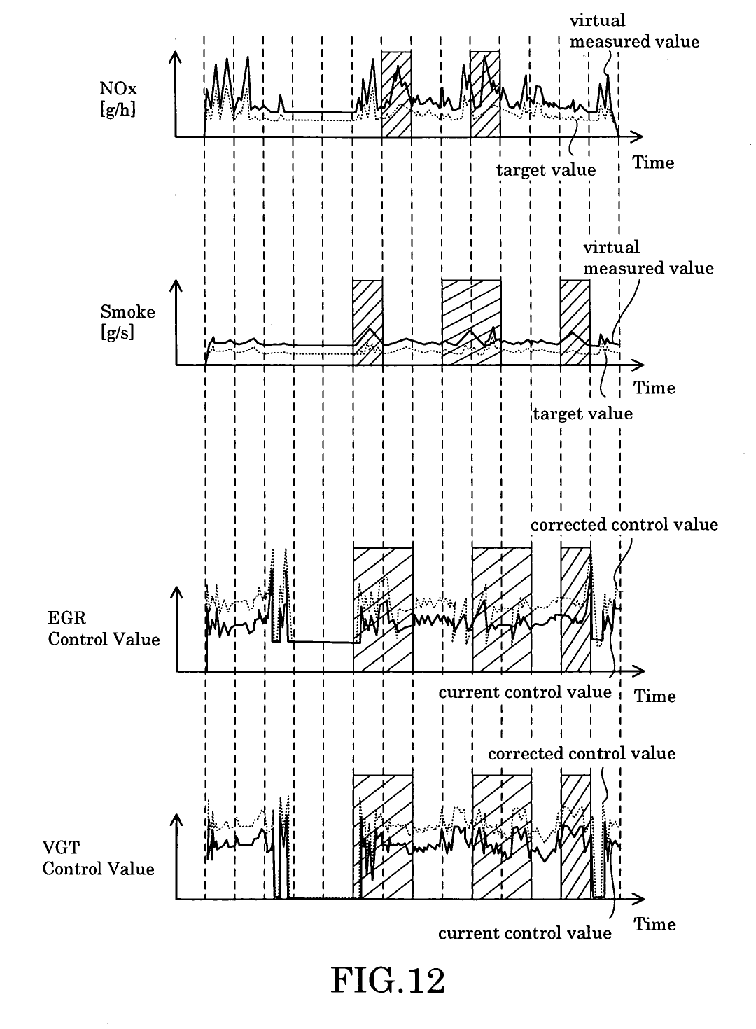

In order to perform display using a different display pattern, it is preferable that the simulation time is divided into time slits of a unit period of time, and whether the difference is within the permissible levels or not is determined for each of the time slits. Specifically, a time slit in which the integrated value of the difference between the simulation results and the target value exceeds a threshold value is displayed in a display pattern different from that for the other time slits. FIG. 11 and FIG. 12 illustrate display examples in which the simulation time is divided into time slits. In the example of FIG. 11, the simulation results (virtual measured value) and the target value are displayed in parallel divided into time slits. In the example of FIG. 12, the virtual measured value and the target value in the time slits in which the difference between the simulation results and the target value exceeds the permissible limits are displayed in a manner different from the other time slits. Furthermore, the control value of the corresponding time slits is also displayed in a different manner from the other time slits. In FIGS. 11 and 12, while the display in a different manner is achieved by hatching, display in a different color is preferable in practical use.

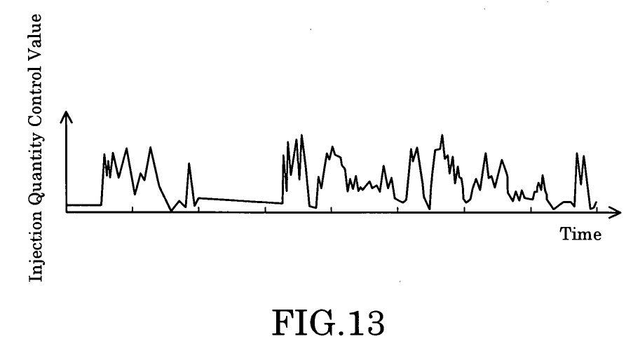

In the above description, the EGR control value and the VGT control value were used as examples of the controlled factor. However, the above description is also possible with other controlled factors. For example, as illustrated in FIG. 13, the control value of the fuel injection quantity corresponding to the transition state of NOx and smoke illustrated in FIG. 7 can be used for the description.

As described so far, according to the present invention, when setting engine control values that satisfy the performance objectives by simulating transition states of an engine, an operator can visually perceive the setting conditions of the control values. The present invention can reduce the time needed for engine development and can reduce the duration of product development.

### INDUSTRIAL APPLICABILITY

The virtual engine test instrument 1 in the foregoing embodiment, especially, the virtual ECU 3, the engine simulating unit 5 and the control value operating unit 4 can be implemented with a general information processing system. The present invention can be implemented as a computer program that realizes the above units when installed on a general information processing system. Further, the present invention can be implemented as a storage medium on which such a computer program is stored and that is readable by information processing systems.

1. An engine transition test instrument comprising:
virtual engine test means for simulating a transition state in which an engine rotational speed or torque changes with time,
wherein the virtual engine test means comprises
simulation means for simulating behavior of an engine by a transition engine model created based on data obtained by driving an actual engine while changing a value of at least one controlled factor;
virtual control means that emulates actual control means that controls an actual engine, and supplies an engine control signal to the simulation means; and
control value operation means that supplies a control value for the controlled factor to the virtual control means, causes simulation results by the simulation means to be displayed on display means of an operator, and corrects the control value according to an operation by the operator,
wherein the control value operation means comprises means for causing a control value used for the simulation to be displayed in a time-series graph on the display means along with the simulation results.

2. The engine transition test instrument according to claim 1, further comprising:
means for conducting a transition test on actual engine using a control value corrected by the control value operation means; and
means for updating a transition engine model in the simulation means based on test results by the means for conducting the transition test.

3. The engine transition test instrument according to claim 1, wherein the control value operation means updates a control value according to a drag operation by an operator with respect to the control value displayed as a graph on the displaying means.

4. The engine transition test instrument according to claim 1, wherein the control value operation means causes a target value for a simulation by the simulation means to be displayed on the display means in parallel with simulation results.

5. The engine transition test instrument according to claim 1, wherein with respect to a portion in which the difference between simulation results and a target value exceeds a permissible limit, the control value operation means causes the simulation results to be displayed in a display pattern different from that for the other portions.

6. The engine transition test instrument according to claim 1, wherein with respect to a control value that corresponds to a portion in which the difference between simulation results and a target value exceeds a permissible limit, the control value operation means causes the control value to be displayed in a display pattern different from that for the other portions.

7. The engine transition test instrument according to claim 1, wherein the control value operation means divides the simulation time into time slits of a unit period of time, and causes a time slit in which an integrated value of the difference between simulation results and a target value exceeds a threshold value to be displayed in a display pattern different from that for the other time slits.

8. An engine transition test method comprising:
a first step of creating a transition engine model created based on data obtained by driving an actual engine while changing a value of at least one controlled factor in a transition state in which an engine rotational speed or torque changes with time,
a second step of assuming the transition engine model as a virtual engine, and displaying a control value for the controlled factor for operating the virtual engine;
a third step of emulating actual control means that controls an actual engine and supplying an engine control signal to the virtual engine based on the control value;
a fourth step of displaying simulation results of operating the virtual engine according to the engine control signal; and
a fifth step of correcting the control value according to the displayed simulation results,
wherein the second through the fifth steps are repeated until the simulation results satisfy a performance objective;
in the second step, the control value is displayed in a time-series graph; and
in the fourth step, the simulation results are displayed in parallel with the graph display of the control value.

9. The engine transition test method according to claim 8, further comprising:
a sixth step of providing a control value with which a performance objective has been satisfied by repeating the second through the fifth steps to control means of an actual engine, and conducting an actual transition test on the actual engine; and
a seventh step of updating the transition engine model based on results of the transition test,
wherein the second through the fifth steps are repeated with the updated transition engine model.

10. The engine transition test method according to claim 8, wherein in the fifth step, with respect to the control value displayed in a graph in the second step, the control value is updated by an operator performing a dragging operation.

11. The engine transition test method according to claim 8,
wherein in the second step or the fourth step, a target value for a simulation is displayed in parallel with simulation results in the fourth step.

12. The engine transition test method according to claim 8, wherein in the fourth step, with respect to a portion in which the difference between simulation results and a target value exceeds a permissible limit, the simulation results of that portion are displayed in a display pattern different from that for the other portions.

13. The engine transition test method according to claim 8, wherein in the fourth step, a control value corresponding to a portion in which the difference between simulation results and a target value exceeds a permissible limit is displayed in a display pattern different from that for the other portions.

14. The engine transition test method according to claim 8, wherein in the fourth step, the simulation time is divided into time slits of a unit period of time, and a time slit in which an integrated value of the difference between simulation results and a target value exceeds a threshold value is displayed in a display pattern different from that for the other time slits.

15. A computer program that realizes, by being installed on an information processing system:
simulation means for simulating behavior of an engine by a transition engine model created based on data obtained by driving an actual engine while changing a value of at least one controlled factor;
virtual control means that emulates actual control means that controls an actual engine, and supplies an engine control signal to the simulation means;
control value operation means that supplies a control value for the controlled factor to the virtual control means, causes simulation results by the simulation means to be displayed on a display screen of an operator, and corrects the control value according to an operation by the operator; and
means for causing a control value used for the simulation to be displayed in a time-series graph on the display means along with the simulation results.

16. A storage medium that is readable with an information processing system on which the computer program according to claim 15 is stored.
